(19) United States
(12) Patent Application Publication
(10) Pub. No.: US 2003/0128105 A1
(43) Pub. Date: Jul. 10, 2003

(54) Hitch-mounted lighting and safety accessory

(76) Inventor: Raymond W. Shaw, Wells, ME (US)

Correspondence Address: Kevin M. Farrell, Pierce Atwood, One New Hampshire Avenue, Suite 350, Portsmouth, NH, 03801, US

(21) Appl. No.: 10/043,001

(22) Filed: Jan. 9, 2002

(51) Int. Cl. G08B 21/00

(52) U.S. Cl. 340/431; 340/463

(57) ABSTRACT

Disclosed is a hitch-mounted lighting and safety accessory for a vehicle having a frame-mounted hitch sleeve. The hitch-mounted accessory includes tubing stock having a first and a second end, the first end being adapted for secure and reversible insertion into a hitch sleeve. When installed, the first end and an extension thereof sufficient to clear the rear of the vehicle, extend horizontally (relative to the ground) from the hitch sleeve. The tubing stock is then redirected a total of about 90 degrees at a location proximate the first end so that it extends upwardly in a substantially vertical plane. Accessories such as a safety beacon light or strobe, work lights, and an audible back-up alarm are mounted to the tubing stock. A wiring harness terminating in a male plug for insertion into a female plug mounted to the vehicle near the hitch sleeve is also provided.

### BACKGROUND OF THE INVENTION

Safety beacons, strobe lights, work lights and audible back-up alarms are commonly used accessories in the construction industry. For example, safety beacons and strobe lights provide early notice to motorists that caution is required because a slow moving piece of equipment may be in close proximity to a roadway. Audible back-up alarms are extremely important around job-sites where pedestrians are walking about while large pieces of construction equipment, frequently having substantial blind spots, are working on the site.

Such accessories are desirable from time-to-time on highway registered vehicles owned by individuals, not just municipalities. An example of a vehicle application where such accessories are highly desirable is a plow truck. Frequently, plow trucks are standard pick-up trucks used for everyday purposes in the absence of a fresh snow fall. When the weather turns to snow, plows are mounted to such trucks.

Some states require safety beacons or strobe lights to be mounted to plow trucks. In order to be visible, such a light or beacon should be mounted above the roof line of a truck. This requires drilling into the roof or the mounting of a supporting member. In addition, the mounting of such a light has several disadvantages associated with it. Some would view the light as detracting from the aesthetics of the vehicle. Many car washes will not permit a truck having such an auxiliary light to pass through. Parking garages may not have the height clearance necessary to accommodate a truck having such an accessory light mounted.

With respect to back-up alarms, they would be viewed by many as unnecessary and annoying when a truck is not being used for plowing. While a back-up alarm could be mounted with a switch, this increases the expense associated with the installation.

A product providing a convenient means for reversibly mounting the accessories referred to above would be highly desirable.

### SUMMARY OF THE INVENTION

The present invention relates to a hitch-mounted lighting and safety accessory for a vehicle having a frame-mounted hitch sleeve. The various elements of the device are attached to tubing stock having a first and a second end. The first end of the tubing stock is adapted for secure and reversible insertion into a hitch sleeve. The tubing stock being redirected a total of about 90 degrees at a location proximate the first end. The elements attached to the tubing stock include: a safety beacon light or strobe light; one or more work lights; an audible back-up alarm; and a wiring harness terminating in a male plug for insertion into a female plug mounted to the vehicle near the hitch sleeve.

### BRIEF DESCRIPTION OF THE DRAWINGS

FIG. 1 is a rear view of the safety accessory of the hitch-mounted lighting and safety accessory of the present invention.

FIG. 2 is a side view of the safety accessory of the hitch-mounted lighting and safety accessory of the present invention.

### DETAILED DESCRIPTION OF THE INVENTION

The present invention relates to a hitch-mounted lighting and safety accessory for a vehicle having a frame-mounted hitch sleeve. Frame-mounted hitch sleeves are common factory options on sport utility vehicles and trucks (e.g., pick-up trucks, dump trucks, etc.). Aftermarket hitch sleeves are also widely available for installation after a vehicle is purchased. Such hitch sleeves are available in a variety of ratings, depending upon the amount of towing weight which they are rated for. Commonly, such hitch sleeves accommodate a 2 inch square tubular (or solid) draw bar. In addition, vehicles equipped with such a frame-mounted hitch are typically equipped with a wiring harness having a female plug mounted near the hitch sleeve. Four-pin flat plugs are typical in automobiles and light sport utility vehicles. A 4-pin flat connector is typically wired to provide the following circuit functions: common ground; tail/running lights; left turn/stop; and right turn/stop. 6 or 7-pin round plugs are more common on vehicles used in plowing applications. The 6 or 7-pin wiring systems tend to differ from the 4-pin schemes in that left turn, right turn and brake indicators are provided on separate circuits. In addition, one or more auxiliary circuits are provided. A back-up lighting circuit is a commonly provided accessory circuit.

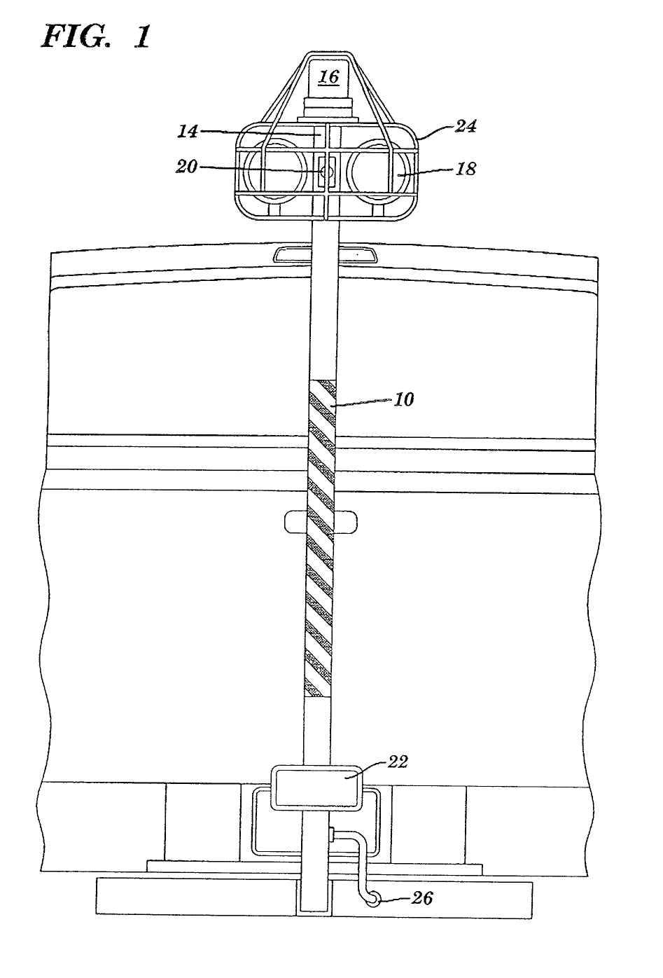

Referring to FIG. 1, the present invention includes tubing stock (10) having a first end (not shown) and a second end (14), the first end being adapted for secure and reversible insertion into a hitch sleeve. Preferably, the tubing stock exits the hitch sleeve and then extends upwardly at an orientation approximately 90 degrees from horizontal. In preferred embodiments, the tubing stock is 2 inch square tubing stock, with walls of about ⅛ inch in thickness. Such stock is very strong and durable, yet it can be bent easily using appropriate equipment. Preferred embodiments do not contain a single 90 degree bend, but rather have a phased transition to 90 degrees from horizontal.

While square tubing stock is preferred, this is not strictly required. In addition, the tubing stock need not be continuous. For example, two or more tubular elements could be coupled using a bracket or gusset system to provide the desired overall dimensions. The overall height when the accessory is installed in a hitch sleeve should provide for the desired visibility without blinding the vehicle operator by light reflecting from the vehicle's rear view mirror. In preferred embodiments, the second end (14) terminates above the roof line of the vehicle.

The tubing stock provides an attachment point for a variety of desirable accessories. Such accessories include, for example, safety beacon or strobe lighting (16), work lighting (18), audible back-up alarm (20), brake lighting (22), etc. In preferred embodiments the strobe or safety beacon (16) is mounted at or near the second end (14) of the tubing stock. This provides for high visibility from ahead of, or behind the vehicle. In preferred embodiments, work lights are also mounted near the second end of the tubing stock. In addition to providing wide angle lighting, mounting such lights high on the tubing stock tends to move them up and out of the grime draft produced at the back of a vehicle operating on a snowy or slushy roadway. A protective cage (24) is provided to protect the lighting from impact damage. A back-up alarm (20) and brake indicator light (22) are also attached to the tubing.

The wiring to these mounted accessories are terminated in a male plug (26), preferably of the 6 or 7-pin variety. This plug is inserted into the female plug provided with factory mounted or aftermarket frame-mounted hitch receivers. Preferably, the wires are connected such that: i) the safety beacon light or strobe light runs continuously when the male plug of step 3 is inserted into the female plug, or runs continuously when the running lights are on; ii) the work lights are on when the vehicle is in reverse; and iii) the audible back-up alarm is on when the vehicle is in reverse. If a brake indicator light is provided, it is wired so that it is activated when a vehicle operator steps on the brake pedal.

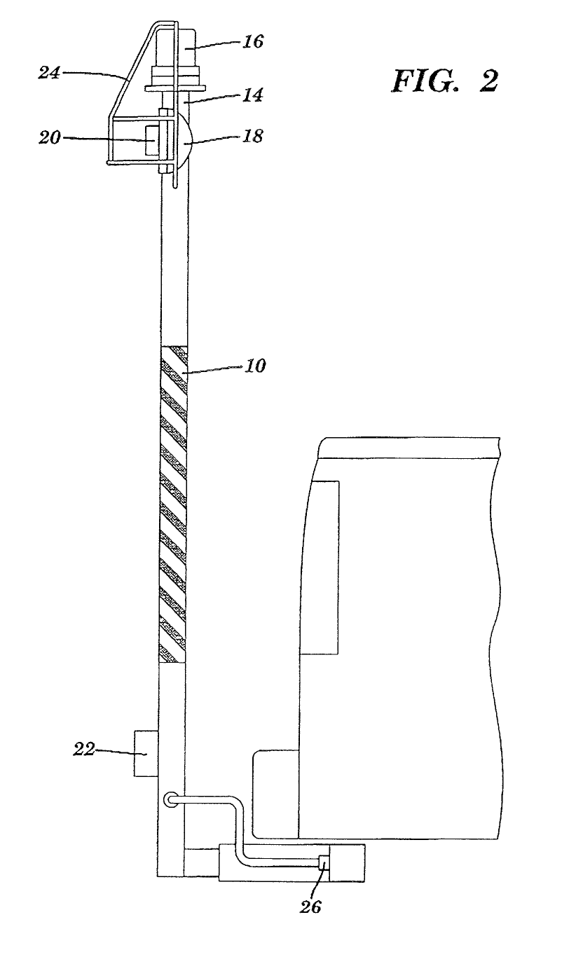

Referring to FIG. 2, the device of the present invention is shown in side view. The side view shows the first end (12) of the device which is adapted for insertion into a hitch sleeve. Also shown in FIG. 2 are the accessories discussed above, including brake light indicator (22), audible back-up alarm (20) work lighting (38), safety beacon or strobe lighting (16) and protective cage (24).

1. A hitch-mounted lighting and safety accessory for a vehicle having a frame-mounted hitch sleeve, comprising:
a) tubing stock having a first and a second end, the first end being adapted for secure and reversible insertion into a hitch sleeve, the tubing stock being redirected a total of about 90 degrees at a location proximate the first end;
b) a safety beacon light or strobe light mounted to the tubing stock;
c) one or more work lights mounted to the tubing stock;
d) an audible back-up alarm mounted to the tubing stock; and
e) a wiring harness terminating in a male plug for insertion into a female plug mounted to the vehicle near the hitch sleeve, the wires comprising the wiring harness being connected such that:
i) the safety beacon light or strobe light runs continuously when the male plug of step 3 is inserted into the female plug, or runs continuously when the running lights are on;
ii) the work lights are on when the vehicle is in reverse; and
iii) the audible back-up alarm is on when the vehicle is in reverse.

2. The hitch-mounted lighting and safety accessory of claim 1 further comprising a brake indicator light mounted to the tubing stock and wired such that the brake indicator light is activated when the brake pedal of the vehicle is depressed.

3. The hitch-mounted lighting and safety accessory of claim 1 wherein the tubing stock is square tubing stock.

4. The hitch-mounted lighting and safety accessory of claim 3 wherein the square tubing stock is 2 inch square tubing stock.

5. The hitch-mounted lighting and safety accessory of claim 4 wherein the 2 inch square tubing stock has a wall thickness of about ⅛ inch.

6. The hitch-mounted lighting and safety accessory of claim 1 wherein the safety beacon light or strobe light is mounted at or near the second end of the tubing stock.

7. The hitch-mounted lighting and safety accessory of claim 1 wherein the one or more work lights are mounted at or near the second end of the tubing stock.

8. The hitch-mounted lighting and safety accessory of claim 1 wherein the about 90 degrees of redirection of step a) is effected by the introduction of one or more bends in the tubing stock.

9. The hitch-mounted lighting and safety accessory of claim 1 wherein the about 90 degrees of redirection of step a) is effected by cutting and welding of the tubing stock.

10. The hitch-mounted lighting and safety accessory of claim 1 wherein the tubing stock is discontinuous and the about 90 degrees of redirection of step a) is introduced using on or more angled gussets.

11. The hitch-mounted lighting and safety accessory of claim 1 wherein the male plug of step e) 6-pin round plug.

12. The hitch-mounted lighting and safety accessory of claim 1 wherein the male plug of step e) 7-pin round plug.

13. The hitch-mounted lighting and safety accessory of claim 1 wherein the lights of steps a) and b) are surrounded by a protective cage.

14. A method for providing work lighting and safety accessories for a vehicle having a frame-mounted hitch sleeve, the method comprising:
a) providing a hitch-mounted lighting and safety accessory comprising:
i) tubing stock having a first and a second end, the first end being adapted for secure and reversible insertion into a hitch sleeve, the tubing stock being redirected a total of about 90 degrees at a location proximate the first end;
ii) a safety beacon light or strobe light mounted to the tubing stock;
iii) one or more work lights mounted to the tubing stock;
iv) an audible back-up alarm mounted to the tubing stock; and
v) a wiring harness terminating in a male plug for insertion into a female plug mounted to the vehicle near the hitch sleeve, the wires comprising the wiring harness being connected such that: the safety beacon light or strobe light runs continuously when the male plug is inserted into the female plug, or runs continuously when the running lights are on; the work lights are on when the vehicle is in reverse; and the audible back-up alarm is on when the vehicle is in reverse; and
b) mounting the lighting and safety accessory in the hitch sleeve; and
c) plugging the male plug of step a) v) into the female plug of step a) v).

15. The method of claim 14 wherein the hitch-mounted lighting and safety accessory further comprises a brake indicator light mounted to the tubing stock and wired such that the brake indicator light is activated when the brake pedal of the vehicle is depressed.

16. The method of claim 14 wherein tubing stock of the hitch-mounted lighting and safety accessory is square tubing stock.

17. The method of claim 16 wherein the square tubing stock is 2 inch square tubing stock.

18. The method of claim 17 wherein the 2 inch square tubing stock has a wall thickness of about ⅛ inch.

19. The method of claim 14 wherein the safety beacon light or strobe light is mounted at or near the second end of the tubing stock.

20. The method of claim 14 wherein the one or more work lights are mounted at or near the second end of the tubing stock.

21. The method of claim 14 wherein the about 90 degrees of redirection of step a) i) is effected by the introduction of one or more bends in the tubing stock.

22. The method of claim 14 wherein the about 90 degrees of redirection of step a) i) is effected by cutting and welding of the tubing stock.

23. The method of claim 14 wherein the tubing stock is discontinuous and the about 90 degrees of redirection of step a) i) is introduced using on or more angled gussets or brackets.

24. The method of claim 14 wherein the male plug of step a) v) is a 6-pin round plug.

25. The method of claim 14 wherein the male plug of step a) v) is a 7-pin round plug.

26. The method of claim 14 wherein the lights of step a) are surrounded by a protective cage.
